(19) United States
(12) Patent Application Publication
(10) Pub. No.: US 2015/0319402 A1
(43) Pub. Date: Nov. 5, 2015

(54) PROVIDING VIDEO RECORDING SUPPORT IN A CO-OPERATIVE GROUP

(71) Applicant: International Business Machines Corporation, Armonk, NY (US)

(72) Inventors: Kelly Abuelsaad, Somers, NY (US); Gregory J. Boss, Saginaw, MI (US); Soobaek Jang, Hamden, CT (US); Randy A. Rendahl, Raleigh, NC (US)

(73) Assignee: International Business Machines Corporation, Armonk, NY (US)

(21) Appl. No.: 14/268,055

(22) Filed: May 2, 2014

(51) Int. Cl. H04N 5/91; G06K 9/00

(52) U.S. Cl. CPC H04N 5/91; G06K 9/00288

(57) ABSTRACT

In an approach to requesting a recording of a focal point in a group event, a computer receives a request from a first user for registration to a group which has at least two attendees of an event with an interest in recording the event. Additionally, the computer receives from the first user a request to view one or more real time recordings from the group. Upon receiving a request to record a focal point from the first user and based, at least in part, on the one or more real time recordings, the computer determines a second user in the group with a view of the focal point. The computer then sends the request to record the focal point to the second user.

### FIELD OF THE INVENTION

The present invention relates generally to electronic media recording, and more particularly to co-operative group electronic media recording utilizing mobile devices and facial recognition.

### BACKGROUND OF THE INVENTION

The proliferation of mobile devices (smart phone, tablets, etc.) with rapidly improving photographic and video capabilities allows people to record events for themselves or for public viewing and sharing online. Some smart phone developers focus on improving video and photographic quality of their phones as selling points to increase mobile phone sales in the marketplace. It is estimated that more than one hundred hours of video, some of which is recorded on mobile devices, is uploaded to the Internet every minute. Additionally, it is estimated that over six billion hours of video, many of which originate on mobile devices, are watched online. Major news networks and local television networks make use of amateur video in some news reports such as recordings of natural disasters or other noteworthy events captured by individuals on mobile devices. Television networks may generate online assignment desks where individuals can view topics of national interest, such as the Olympics, recent political events, and tornados or other severe weather events, while local online assignment desks may include local high school, college, and severe weather events or political activities of local interest, with videos supplied by interested individuals. The network news editors can select from both internally, network recorded video and externally, amateur supplied video to create a quality newscast.

### SUMMARY

Embodiments of the present invention disclose a method, computer program product, and computer system for requesting a recording of a focal point in a group event. The method includes a computer receiving a request from a first user for registration to a group which has at least two attendees of an event with an interest in recording the event. Additionally, the computer receives, from the first user, a request to view one or more real time recordings from the group. Based, at least in part, on the one or more real time recordings, and upon receiving a request to record a focal point from the first user, the computer determines a second user in the group with a view of the focal point. The computer then sends the request to record the focal point to the second user.

### BRIEF DESCRIPTIONS OF THE SEVERAL DRAWINGS

FIG. 1 is a functional block diagram illustrating a data processing environment, in accordance with an embodiment of the present invention.

FIG. 2 is a flow chart depicting operational steps of a co-operative video program within the data processing environment of FIG. 1, for co-operatively recording video of a requested focal point or person and providing individualized, compiled videos, in accordance with an embodiment of the present invention.

FIG. 3 is an exemplary flow diagram depicting operation of the co-operative video program of FIG. 2 by a member of a co-operative group requesting video support for recording a focal point of interest, in accordance with an embodiment of the present invention.

FIG. 4 depicts a block diagram of the components of the server computer of FIG. 1, in accordance with one embodiment of the present invention.

### DETAILED DESCRIPTION

Embodiments of the present invention recognize that with mobile device applications, there exists the ability to set-up a co-operative group of individuals or an ad hoc video group who may download or send video directly to a server or other storage device as they record a specific event. The individuals may review and retrieve video recordings or clips of recordings after the event to create their own video of the event using a mix of video from their own recordings and those from one or more other members of the co-operative video group.

Embodiments of the present invention provide the ability for members of the co-operative group to work together in a real-time environment sharing real time views of each member's video or multimedia recordings. A member of the group may review the real time recordings from the other group members and request recording support from another group member with a different location and better view of a focal point of interest. Each member of the co-operative group registered for the event may request video or multimedia support for recording an identified focal point of interest to the requesting member. Similarly, each member of the co-operative group registered for the event may receive requests to provide video support recording a focal point of interest identified by another member of the group.

Additionally, embodiments of the present invention provide a method, a computer program product, and a system to automatically create a customized video based on the requests of a group member desiring a video recording of specified focal points of interest such as individuals or activities. Embodiments of the present invention use one or more of the following techniques: facial recognition, object recognition, gait recognition, metadata analysis and audio recognition to identify the focal point of interest in the video recordings of the event retrieved from each recording member of the group event, to create an individualized, custom video selected and compiled from the group recorded video of the focal point of interest to a group member.

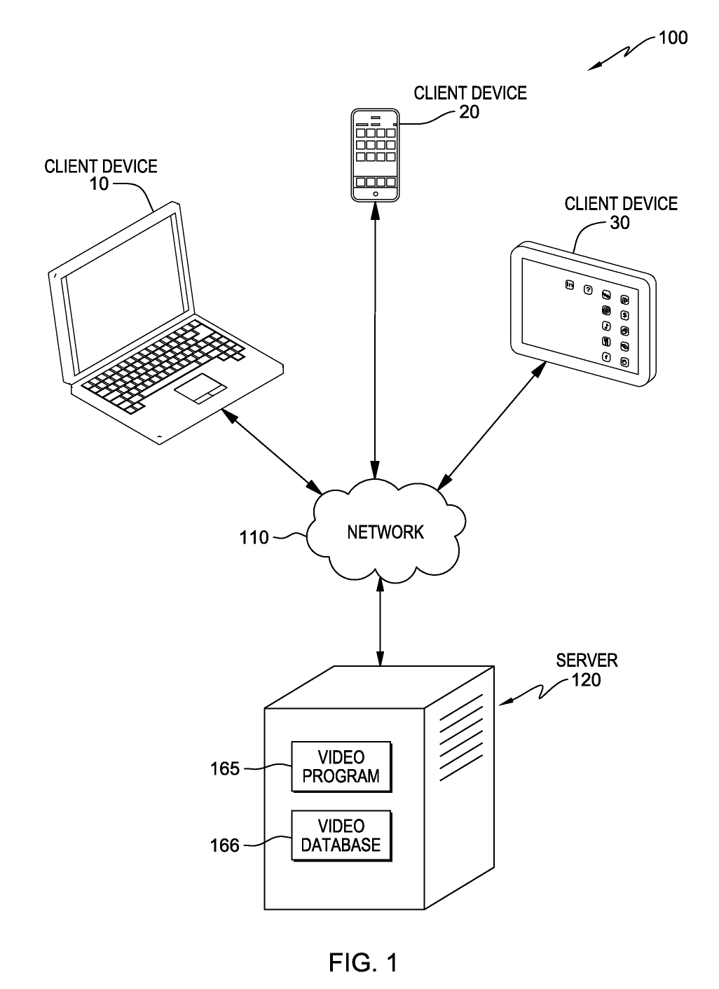

The present invention will now be described in detail with reference to Figures. FIG. 1 is a functional block diagram illustrating a data processing environment, generally designated 100, accordance with an embodiment of the present invention.

In an exemplary embodiment of the present invention, data processing environment 100 is an environment for a co-operative video program used by group of people video recording an event. Data processing environment 100 includes client device 10, client device 20, and client device 30, referred to as client devices 10, 20 and 30 in future references, connected to each other and to server 120 via network 110.

Network 110 may be a local area network (LAN), a wide area network (WAN), virtual local area network (VLAN) such as the Internet, or any combination of the three, and can include wired, wireless, or fiber optic connections. In general, network 110 can be any combination of connections and protocols that will support communications between client devices 10, 20, and 30 and server 120. In an exemplary embodiment, client devices 10, 20, and 30 are connected to each other and to server 120 via network 110 which is a wireless network with utilizing any one or more of second generation (2G), third generation (3G), fourth generation (4G), Long Term Evolution (LTE) or Bluetooth technologies or similar wireless technology for connections.

In various embodiments, client devices 10, 20 and 30 may be an electronic device such as a smartphone, a tablet, a portable computer, a notebook computer, a personal digital assistant (PDA), a laptop computer, or similar electronic device with video recording capability and a network connection. In some embodiments, client devices 10, 20, and 30 may be a digital video camera with network capability or a digital camera with video recording capability and network capability or a similar electronic device capable of recording an event and communicating over a network.

Client devices 10, 20 and 30 may be computing devices capable of recording video clips, video segments, or a full video recording of some or all of a live, currently occurring event, demonstration, presentation, person or persons, place or object. In an exemplary embodiment, client devices 10, 20, and 30 are smart phones or tablet devices with video recording capability and an ability to receive multiple video streams in real time, including high resolution and low resolution video. Client devices 10, 20 and 30 may be capable of sending and receiving images, messages, text, voice, or video in a substantially real time manner. For purposes of the embodiments of the present invention, a substantially real time manner means that there may be small delays in data receipt or transmittal due to processing and network transmission but, a substantially real time manner is close to real time video and will be referred to as real time video in future references. Client devices 10, 20 and 30 may be able to communicate with each other and may be connected in a co-operative video group that can be initiated by a software application within data processing environment 100, for example, co-operative video program 165. Additionally, client devices 10, 20 and 30 may send video or multimedia recordings to a database within data processing environment 100, such as video database 166 on server 120 via network 110.

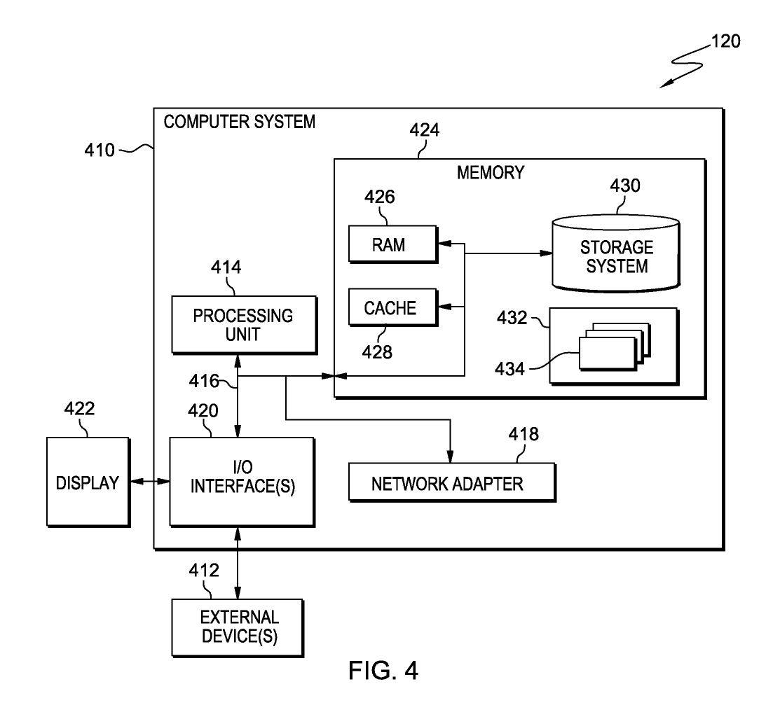

Server 120 may be a server computer or a server computer system such as a management server, a web server, a group of clustered computing devices utilizing multiple computing devices such as a cloud computing environment or any other electronic device or computing system capable of communicating with client devices 10, 20, and 30 via network 110 and of sending, receiving, editing and processing digital video recordings and using the functions related to processing and identifying video of a focal point of interest. Server 120 can use video processing technology such as facial recognition, object recognition, audio recognition, metadata, gait recognition, or other similar functions or technologies. Additionally, server 120 may be capable of using or accessing applications, programs or functions for identifying, selecting, editing and compiling a video clip of a requested focal point elsewhere within data processing environment 100 via network 110. Server 120 includes co-operative video program 165 and video database 166. Server 120 may include internal and external hardware components, as depicted and described in further detail with respect to FIG. 4.

Co-operative video program 165 allows users to set-up a co-operative video group of individuals operating client devices, such as client devices 10, 20, and 30, who may wish to co-operatively record an event, and within the group, users may send and receive real time requests for multimedia and video recording via network 110. Real time requests may be requests for immediate action based on a review of real time video recordings, although, some requests received may identify, for example, a spot or podium for a speaker to address an audience in a couple of minutes. Users may send requests for video recording support, for example, requesting video of a specific focal point such as a person, people, objects, groups of objects, an activity or activities that are occurring at or within the event. The request may include information on the specific focal point, which may be a person or a group of people, a specific activity, a sound or voice pattern, or a specified period of time, for example, twenty minutes, an hour, an event duration, or even more specific, such as recording a final lap of a race.

Co-operative video program 165 enables members of the group to send and receive requests for a specific type of recording, for example, zooming in on the focal point, still shots, video tracking of an activity, an action, object or focal point, a panoramic view, and audio and audio recording support of a solo in a concert. A request for video recording support may include a short text in an active line which may be provided with a request tab, icon or menu initiation of a request. A zoom may be indicated by holding a cursor or touching the focal point of interest. In some embodiments, the selection of a marker for the focal point of interest may indicate to the receiving group member the type of video recording desired. For example, a red marker on the focal point or box around the focal point may indicate a close-up or zoom of the focal point while a blue marker or box may indicate to have the receiving user follow action of the focal point for the duration indicated with the box or marker on the screen.

A user may send a request to co-operative video program 165, for example, when the user has an obstructed view of the person, child, instrument, race car or other focal point of interest. Requests to co-operative video program 165 for video recording support may be as specific as “Can you video tape the swan dance at the start of the second act and zoom in on the black swan?” or “Can you zoom in on number five for the next foul shot?” or more general requests such as “Can you zoom in on my child located in the second row, third in on the right?” A user may hold a cursor on a focal point or touch a focal point for the duration of time the requesting user would like the other user to provide video recording support recording the focal point.

In embodiments, a user may request a compiled video from co-operative video program 165. Co-operative video program 165 may automatically create video recordings or video clips of the targeted or the requested focal point such as a person, area, object or activity. Co-operative video program 165 can retrieve videos taken by each member of the co-operative group from a video database, for example, video database 166 on server 120. Co-operative video program 165, for the user requesting a compiled video, identifies video clips or segments of video taken by the members of a group event and compiles the relevant images or most appropriate segments of video of the requested focal point. Using one or more of the following techniques and technologies such as facial recognition, object recognition, audio recognition, gait recognition, time sequence, specified time, location, quality of the video or metadata, co-operative video program 165 can automatically compile a video of a focal point which may be a person, a group of people, an object or objects, an activity or activities as requested for a group event by a user registered to the event.

Co-operative video program 165 may send compiled video or multimedia recordings to the requesting user on their smart phone, tablet, or other registered client device, for example, client devices 10, 20, and 30. When registering for an event or with a co-operative video group, the user requesting a compiled video may include a computer user-id to which compiled video can be sent, in addition to registering the user's client device.

Video database 166 stores real time video recordings, video clips, audio clips, video segments or other related multimedia data from client devices 10, 20 and 30 for each of the registered group of users for an event. In an embodiment, video database 166 may store compiled videos compiled by co-operative video program 165. In some embodiments, video database 166 resides on another server, computing device, or on a group of servers in a distributed computing environment such as a cloud or server farm within data processing environment 100 and accessible via network 110. Co-operative video program 165 utilizes the stored video in video database 166 to select, edit and determine the compiled video as requested by the users.

Video database 166 may store multimedia or recorded video and identify the individual recordings by a number of identifiers or recording elements. Video recordings may be stored using identifiers or metadata, including the name of the group event, the time recorded, the user-id or the user name of the recorder, the client device recording the video, the location of the device recording from global positioning system (GPS), the device type and model of the recording client device, extracted metadata from the client device or user entered metadata identifiers such as focal point name, activity, or other event timeline identifier. Video database 166 stores real time video or video streams, video clips, audio clips or video segments or full videos related to an event that may be retrieved by co-operative video program 165.

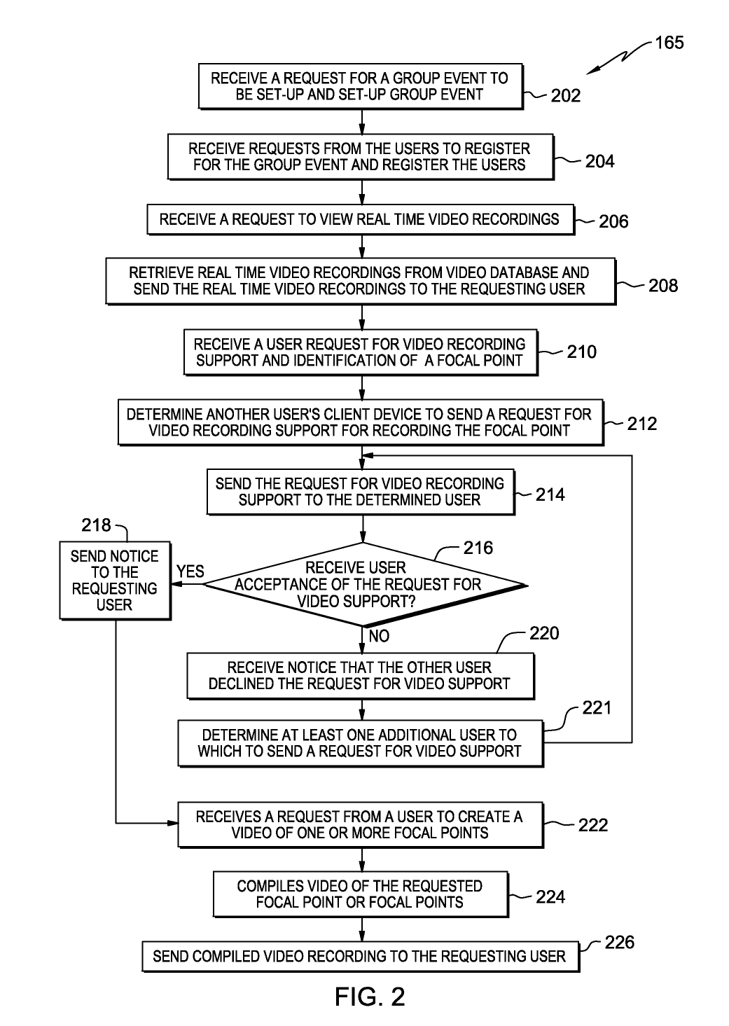

FIG. 2 is a flow chart depicting operational steps of co-operative video program 165, for co-operatively recording video of a requested focal point or person and providing individualized compiled videos, in accordance with an embodiment of the present invention.

In step 202, co-operative video program 165 receives a request for a group event to be set-up as a co-operative group event for recording and in response, sets-up the group event. The group event may include at least two attendees of the event that are interested in recording the event, or in obtaining recordings of the event. A user requesting co-operative video program 165 to set-up or configure a co-operative group event for recording may provide co-operative video program 165 with at least one or more of the following information: event name, event time, event estimated length of time, event location, event sponsor, an estimation of number of attendees, and any other pertinent event specified information.

In step 204, co-operative video program 165 receives requests from users to register for the group event and registers the users. A user may launch co-operative video program 165 which may be for example, an icon or tab on the start-up screen of client device 10, for example, and use a menu option in the program such as “find event” to provide an active input line to query co-operative video program 165 to locate an event by, for example, an event name, an event location or an event time. In some embodiments, co-operative video program 165 may provide a list of event names, event times and event locations or venues, for example, which may be used to identify and select an event for registration by double tapping, boxing or a using a cursor to identify the desired group event to register for the group event.

Interested users register for the group event in co-operative video program 165 and can implicitly or explicitly agree to share contact information such as mobile device numbers, digital multimedia content such as video, audio and still photographs along with information including global positioning system (GPS), time synchronization, client device digital data capability including client device data resolution capability, for example. 2.0 megapixels (MP), 3.4 MP, 1 gigapixel (GP) and client device image stabilization capability. The user may register with a group event selected in co-operative video program 165 by providing information such as name, mobile device or smart phone number, service carrier, internet access user-id, devices associated with the user and device type or model, and a seat and row number, for example. Additionally, at registration, the user's device may be synchronized to a universal time provider for the group event like the United States Naval Observatory's master atomic clock or Greenwich Mean Time (GMT) and converted as needed to the user's time zone. In an embodiment, each user registered for the group event provides video recordings of the event recorded on each individual device to co-operative video program 165 for storage in video database 166.

In an embodiment of the present invention, as users register with co-operative video program 165, the program tracks the global positioning system (GPS) location of the registered users' client devices and may determine a map identifying the GPS location of each registered user's client device. The map of registered users for the group event may include information such as identifying which user's client device may be actively recording or sending video to co-operative program 165 by displaying an “x”, at the user's location and identifying those users with client devices turned on but not recording with a circle at the user's location on the map of the users' client device location.

In step 206, co-operative video program 165 receives a request to view real time video recordings from the group. A user who has launched or opened co-operative video program 165 may request to receive real time video recordings by selecting, for example, a menu option, icon or tab labeled “review other user views”, on the client device screen.

In step 208, co-operative video program 165 retrieves the real-time video from video database 166 and sends the real time recordings to the requesting user. The requesting user receives on his or her client device, the real time video recordings received by video database 166 from each of the users registered to the group event. The video may be low resolution video to preserve client device bandwidth or alternatively, in some embodiments, may be still images extracted from the real time video at set intervals, for example, every ten seconds and sent to the requesting user. In an embodiment, co-operative video program 165 retrieves the real-time video and posts the video to a meeting website or other collaborating application where each user may view available video using web browser technology.

In some embodiments, using co-operative video program 165 each user may configure or set-up individual client devices or smart phones to receive and view video. Configuring or setting-up client devices may include the manner in which real-time video or still images are viewed by the requesting user. For example, a user may select to configure or set-up his or her client device or smart phone to show ten video streams from other users on his or her device screen or the user may configure the device to receive five video streams on one half of his or her screen and view his or her real-time video recording on the other half of his or her screen. In another embodiment of the invention, the user may choose to shuffle through the other users' videos by sliding a touch screen to view video recorded by the next ten users or hitting a forward arrow to move on to the next group of users' video streams.

In step 210, co-operative video program 165 receives a user request for video recording support of a focal point, including identification of the focal point of interest to the user. A group event member may elect at any time during the group event's duration to request video recording support from one or more users registered in the group event. The requesting user may use a real time view of the other user's video to identify the focal point to co-operative video program 165. Co-operative video program 165 may receive from a user a request for video recording support for recording a focal point by one or more of several methods.

In an embodiment, the requesting user using a client device with a touch screen selects another user's real time video recording to view by one of several methods. For example, the requesting user may upon reviewing the real time videos or extracted still shots retrieved from video database 166, select a real time video recording or extracted still shot with a view of the focal point by touching, doubling tapping or drawing a box around the other user's video recording. With the selected or identified video recording retrieved from another user in the group, co-operative video program 165 may receive a request for video support recording a focal point when a requesting user identifies on a client device screen the focal point of interest. The identification of the focal point and request for video support recording the identified focal point may be received when a box is drawn around the focal point on the client device screen, a user touches the focal point, or double taps on the focal point on the client device screen. In some cases, a tab or menu may be used to indicate “send request”. In an embodiment where the client device does not have a touch screen, a cursor may be moved up/down or left/right screen to select the video recording of another user. The focal point of interest of the requesting user may also be selected and identified to co-operative video program 165 using a pointer or cursor to identify the focal point by similarly moving the cursor up/down and right/left and selecting “enter”, for example, when the cursor or the pointer location identifies the focal point.

In other embodiments, co-operative video program 165 may receive voice commands from the requesting user to identify the video recording of interest, for example, “select video on the top right corner” on client devices enabled with voice recognition. In this embodiment of the present invention, co-operative video program 165 may also receive requests for video recording support for a focal point by voice recognition. A voice command may be used to request video recording support for a focal point or field of view, for example, “Please select the piano on stage left”. In another embodiment, co-operative video program 165 may receive requests for video support recording a focal point via text messages.

In some embodiments, the GPS map created by co-operative video program 165 showing the locations of the other members in the group may be used to indicate another user's video recording for the requesting user to review. A user interested in viewing another user's real time video may touch or use a cursor to indicate the marker on the GPS map identifying to co-operative video program 165 the user whose video the requesting user would like to view. Co-operative video program 165 retrieves the real time video associated with the selected GPS location marker from video database 166. The requesting user observing on his or her client device screen the other user's video recording, selected using the map of the users' client devices GPS locations, may identify a focal point such as a person, activity or area the requesting user would like recorded by drawing a box around the focal point, touching the focal point, use a pointer, cursors, or voice, for example, to indicate the focal point to co-operative video program 165.

In step 212, co-operative video program 165 determines another user's client device to send a request for video recording support of the focal point of interest. Once co-operative video program 165 has received identification of the focal point of interest from a requesting user's client device by any of the previously discussed methods (e.g. box, touch, cursor, voice, etc.), co-operative video program 165 determines at least one user from which to request video recording support recording the focal point. Co-operative video program 165 may determine another user's client device to send a request to for video recording support of a focal point based, at least in part, on an analysis of the real time video recordings of other members in the group event or the GPS location of the client devices. The determination of another client device to send a request to for video recording support of the focal point may be done utilizing one or more or the following methods to analyze the real time video and/or GPS locations: facial recognition of the focal point, object recognition of the focal point, audio recognition of the focal point's identified sound, gait recognition of the focal point, a timeframe of the recording, metadata on the recording which may include GPS position or location of the client device and the client device recording capabilities (e.g. device image stability, recording capability such as megapixels, etc.) and user entered recording data or text requests. For example, co-operative video program 165 using a map of the users' client device GPS locations to determine a client device to request video support for recording a focal point may choose between two client devices with similar GPS locations by determining which user's client device has better device recording capabilities such as image stability or megapixel capability. In another example, co-operative video program 165 may select a client device using facial recognition to determine the user's client device with the largest recording area (best zoom) of the focal point of interest.

The methods of selecting a video recording of a focal point of interest used by co-operative video program 165 should not be limited to these methods (touch screen, cursor or voice recognition, for example) but, may evolve as client device technology evolves.

In step 214, co-operative video program 165 sends the request for video support recording of the indicated focal point to the determined user. Upon receiving the request for video support and an indication of the focal point of interest from the requesting user's client device, and determining a user from which to request recording support, co-operative video program 165 may send the request to the determined user's client device. Co-operative video program 165 may send a notice or alert to the determined user's client device indicating the focal point of interest by highlighting the focal point, showing the focal point in a box, text, voice command, marking with a marker or an icon such as a star, an x, other icon which may be colored or flashing to identify the focal point or area of interest to the requesting user.

In other embodiments, co-operative video program 165 may send a request for video recording support of the indicated focal point to a user client device selected by the requesting user. A requesting user upon reviewing the real time video recordings may select a video recording from another user's client device by one of the methods previously discussed (touch, cursor, voice, map of client device GPS location, etc.). In the identified user's real time video recording, the requesting user may identify a focal point of interest by one of the methods discussed such as drawing a box around the focal point or moving a cursor to the focal point, for example, and using a tab or pull down menu, may select “send request”. Co-operative video program 165 may send the request for video recording support of an identified focal point to the user's client device that may be selected by the requesting user based on the selected user's client device real time video or GPS location. Co-operative video program 165 may send the request for video recording support to record a focal point to the selected user's client device screen to be identified or displayed on the receiving user's client device as a highlight on the focal point, a box around the focal point, voice command or similar focal point identification.

In some embodiments, the requesting user may chose to select multiple users to send the video recording support request to by touching multiple users' video streams or multiple users on the map and using a tab or pull down screen for a group send button. In some cases, a requesting user may select to request video recording support for recording the focal point from each of the other group members, for example, using a “send to all” request option in the tab or a pull down screen.

In some embodiments, co-operative video program 165 may send a text message or other message requesting video recording support to the identified user's client device view screen where it may be displayed to the user for a short time or, in some cases, until the user responds (accepts or declines the request). Co-operative video program 165 may store the text request as metadata with the video in video database 166 or may extract key words from the text to be stored as metadata in video database 166 with the video recorded in response to the request.

In step 216, co-operative video program 165 determines whether the user accepted the request for video support recording the identified focal point. When a user receives a request for video support, the receiving user may touch the indicated focal point on the client device touch screen, use a voice command or select a tab or icon, for example, labeled “accept” to indicate to co-operative video program 165 an acceptance of the request for video support (the “YES” branch of step 216). Co-operative video program 165 may receive a notice that the other user has declined the request for video support (the “NO” branch of step 216).

In step 218, if a user has accepted the request to provide video recording support (the “YES” branch of step 216), co-operative video program 165 sends a notice to the requesting user's client device. When the selected user receiving the request accepts the request, co-operative video program 165 receiving the acceptance, may send a notice by voice message or a short screen text to the requesting user indicating acceptance of the request for video support.

In some embodiments, co-operative video program 165 can change the color of the box, cursor, icon or marker indicating the focal point of interest on the requesting user's client device screen to indicate acceptance. For example, the “x” marking the focal point of interest may change from red to green indicating the receiving user has accepted the request for video support. In another example, the box, icon or marker may flash to indicate the selected user's acceptance of the request for video support. Additionally, the requesting user may see on his or her device screen the receiving user adjusting the real-time video recording to capture the focal point in the receiving user's real-time video.

In step 220, if a user has declined the request to provide video recording support, co-operative video program 165 receives a notice that the selected user declined the request for video support (the “NO” branch of step 216). A user, receiving a request for video support, may touch, use a voice command, an icon or select a menu item labeled “No”, for example, to indicate to co-operative video program 165 a declined request for video support. When co-operative video program 165 receives a declined request or denied request from the selected user's client device, co-operative video program 165 may send a voice message, a short screen text message stating “declined” to the requesting user's client device, create an “x” or slash through the marker indicating the focal point of interest or a color change of the marker indicating the focal point, for example, to communicate to the requesting user a denial of the request for video recording support.

In some embodiments, co-operative program may not receive a reply from the selected user. In this embodiment, co-operative program 165 may re-send the request for video support to the selected user after a predetermined amount of time, for example ten seconds. In another embodiment, co-operative video program 165 may proceed to determine another client device to which to send the request for video support after a predetermined time such as twenty seconds without a reply to the request for video support. In some embodiments, users registered in the group event may pre-determine a time period in which to receive a reply to a request for video support before a further action is taken by co-operative video program 165.

In step 221, if a user has declined the request, co-operative video program 165 determines at least one additional user to which to send a request for video recording support. In an embodiment, co-operative video program 165 may, using the methods discussed in step 212, automatically identify another co-operative group member with a client device who may be nearby the selected user to send the request for video support using metadata, for example, metadata on client device locations identifying one or more client devices with GPS device locations near the initially requested user's client device. After identifying another user to send the request for video support to, co-operative video program 165 proceeds to step 214 to send the request for video recording support to the determined user. In another embodiment, the requesting user may identify to co-operative video program 165, by previously described methods, another user's client device or a group of selected users' client devices to send another request to record video of the focal point of interest.

In an embodiment, co-operative video program 165 may use one or more of the following techniques to analyze the real time video recordings of the other members of the group event such as facial recognition of the focal point, gait recognition of the focal point, audio recognition of the focal point identified sound, and object recognition of the focal point of interest to determine another user's client device with a view of the focal point in the real time video recording to send the request for video support. In some embodiments, co-operative video program 165 may use metadata extracted from the device or supplied by the user such as a message indicating the focal point (e.g. Jimmy in row one center or soprano section of the choir), to identify another user in the group to send the request for video support. In embodiments, for the initial request, and for additional requests, the requesting user may select to broadcast the request for video support to video record the focal point of interest to each member of the group of registered users at the event.

In step 222, co-operative video program 165 receives a request from a user to create a video recording of one or more focal points of interest. Upon completion of the group event, or at any time after registered users store video recordings of the event in video database 166, co-operative video program 165 may receive the request from a voice command such as “create video”, for example. Co-operative video program 165 may receive a request for an individualized video recording from a user via a tab, an icon, a pull down screen, a command on an active line in co-operative video program 165 or other similar method. In an embodiment, co-operative video program 165, receiving a request to create an individualized video, may provide a list of group events the requesting user registered for so that the requesting user can select the group event of interest. The list of group events may include event name, event time or event location by the line so that the user may indicate an event by touching, by double tapping, cursor, box, or by voice command. The request may also include a specified timeframe such as a compiled video for a child's solo at 09:00 hrs until 09:10 hrs, for example.

Co-operative video program 165 may receive from the requesting user identification of the focal point by one or more of the methods described in steps 206 and 210 to request an individualized, compiled video of the focal point. Co-operative video program 165 retrieves the videos recorded by the users registered for the group event from video database 166. Co-operative video program 165 may receive the user selection of one or more video or video segments recorded by other group members to review and then, co-operative video program 165 may receive an identification of the focal point or focal points of interest by the methods previously described in step 208 (touching, double tapping, voice command or cursor for example).

In another embodiment, co-operative video program 165 uses a record or metadata created with the user generated request for video support to identify focal points of interest, received video, still digital images of the identified focal point or focal points to create an individualized, compiled video for the user.

In step 224, co-operative video program 165 compiles a video recording of the requested focal point or focal points. Upon receiving the request including the focal point or focal points of interest identified by previously discussed methods such as touch, a cursor or voice, co-operative video program 165 retrieves the video recordings from video database 166 taken by each of the users registered for the group event, and using the identified focal point or focal points, searches the video recordings for video recordings containing the one or more requested focal points of interest using techniques such as facial recognition of the focal point, object recognition of the focal point, gait recognition of the focal point, audio recognition of the identified focal point sound, time of the recording or time elapsed (when a recording time for the focal point is specified), GPS location of the recording client device, or metadata, for example user supplied information on the video subject material to identify videos or video segments of the selected focal points of interest. From the retrieved video recordings identified with the requested focal point or focal points, co-operative video program 165 edits, selects, and determines, using any number of methods or filters, a compiled, individualized video of the focal point or focal points of interest for the requesting user.

In various embodiments, the filters may include image quality as determined by co-operative video program 165 analysis of video such as using facial or object recognition to determine focal point centrality in the recording. The filters may also include metadata on recording client device capability as input by the user at event registration or extracted from the client device by co-operative video program 165. The client device capability may include device type information such as device model, device image capability (MPs, lens zoom capability and the zoom level used for a specific video, image stability control capability), audio quality (device audio capabilities), and any other appropriate metadata extracted from the client device or input by the user such as notes on the recording input by the recording user. The metadata may include recording data extracted from the client device such as the zoom level used in the recording, audio input received (level audio sensitivity used e.g. muted or maximum level), client device GPS location while recording, or client device movement during recording.

For example, co-operative video program 165 identified three thirty second recordings of the focal point of interest, a person, using facial and gait recognition. The first recording is recorded in 1080 horizontal line of vertical resolution (1080p), with stability control (no shake) with a five second segment of the focal point walking in front of the camera or smart phone recording. The second recording is recorded in 720 horizontal line of vertical resolution (720p) with a device without stability control and low quality lens and low megapixel capability (i.e. a low budget smart phone). The third recording is in 1080p with some stability control (moderate shake), no obstacles with zoom or a close up view of the person (focal point). To determine or compile the video of the person or focal point of interest, co-operative video program 165 may select the video with the best image quality such as 1080p with image stability of the person walking across the stage for the first five seconds and then, the switch over the third video recording with 1080p, with some image stability provided by the device and zoom or close up of the person (focal point).

In some embodiments, co-operative video program 165 may utilize imaging analysis, audio analysis or digital video imaging analysis tools as known to one skilled in the art to determine the selection of the video clips or segments to include in the compiled video based on image or audio quality such as image clarity, lighting quality (recording too dark or too light), image resolution, etc.

In an embodiment, co-operative video program 165 may edit and compile video of a focal point or focal points of interest for a user registered to the group event but who may not have attended the event. In this embodiment, the user may obtain customized, compiled video recording of an event focal point. The user can retrieve video from the group event and identify the focal points of interest as previously described (steps 206, 208 and 210). Using the information received on the event and focal point of interest, co-operative video program 165 may compile an individualized video for the user.

In step 226, co-operative video program 165 sends the individualized, compiled video of the requested focal point or focal points to the user requesting video via network 110. Co-operative video program 165 sends the compiled video recording to the requesting user client device and any other user-ids or devices the user identifies at group event registration such as another user-id for another family member.

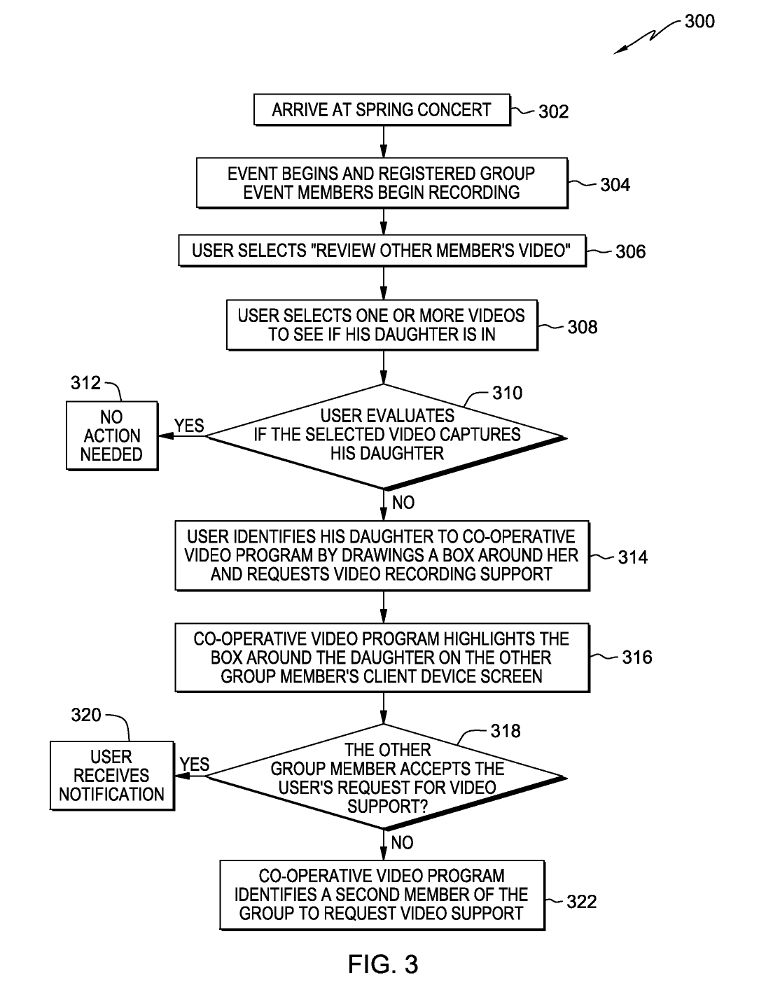

FIG. 3 is an exemplary flow chart 300 depicting operation of the co-operative video program of FIG. 2 by a member of a co-operative group requesting video support for recording a focal point of interest, in accordance with an embodiment of the present invention.

In step 302, a couple arrives at a spring school concert for their daughter, which has already been set up as a group event in co-operative video program 165. The couple each launch co-operative video program 165 from their client device menu, and each register with the group event on their client devices, for example, a smart phone or a tablet.

In step 304, the event begins and the registered group event members begin recording. However, when the children enter the stage, the couple's daughter is on the opposite side of the stage and they cannot clearly see her.

In step 306, the father selects a tab “review other member's video” in co-operative video program 165 and begins receiving real-time video from other users recording group event members on his smart phone screen. The group event videos are retrieved from video database 166 by co-operative video program 165.

In step 308, the father selects on his client device screen one or more of the real time video streams from the other members of the group to see if his daughter (i.e., focal point of interest) is included in the video view.

In step 310, the father reviews the selected video views from the other selected group members to evaluate if the views capture his daughter.

In step 312, the father or user determines that his daughter is captured in the video (the “Yes” branch of step 310), and no further action is required.

In step 314, the father determines that the video views do not capture or capture his daughter (the “No” branch of step 310), and the father or user identifies his daughter to co-operative video program 165 by drawing a box around her on his client device screen and requests video recording support. In the discussed embodiment, the father identifies a video view from the video recordings being taken by the other group members with his daughter clearly shown, and indicates the video support request, for example, zooming in by drawing a box around his daughter. Co-operative video program 165 sends the request for a close-up of the user's daughter in the first row via network 110 to the selected group member's client device that is recording the identified video.

In step 316, co-operative video program 165 highlights or lights up the box around the image of the daughter on the selected group member's client device video screen and indicates that another group member has made a request for a close-up of the focal point (i.e. the daughter).

In step 318, the other group member decides whether to accept the user's request for video support. Upon receiving a request for video support from co-operative video program 165, a receiving user may select to accept or decline the request for video support.

In step 320, when the other group member accepts the request for video support (the “YES” branch of step 318), the requesting user, (here, the father), receives a text notification of acceptance from co-operative video program 165. On his client device screen, he sees a close-up of his daughter in the real-time video being recorded by the other group member accepting his request.

In step 322, the group member receiving the request for video support declines the request (the “NO” branch of step 318), then, co-operative video program 165 automatically identifies a second member of the group, using the methods previously discussed in step 212 of FIG. 2, from which to request video support recording his daughter.

FIG. 4 depicts a block diagram of the components of server 120, in accordance with one embodiment of the present invention. It should be appreciated that FIG. 4 provides only an illustration of one implementation and does not imply any limitations with regard to the environments in which different embodiments may be implemented.

Server 120 includes the components shown in computer system 410. In the illustrative embodiment, server 120 in the data processing system 100 is shown in the form of a computer system 410 however, the capabilities provided by server 120 may be provided by a remote computer, a server, or a cloud of distributed computing devices. The components of computer system 410 may include, but are not limited to, one or more processors or processing units 414, a system memory 424, and a bus 416 that couples various system components including system memory 424 to processing unit 414.

Bus 416 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 410 typically includes a variety of computer system readable media. Such media may be any available media that is accessible by computer system 410, and it includes both volatile and non-volatile media, removable and non-removable media.

System memory 424 can include computer system readable media in the form of volatile memory, such as random access memory (RAM) 426 and/or cache memory 428. Computer system 410 may further include other removable/non-removable, volatile/non-volatile computer system storage media. By way of example only, storage system 430 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 416 by one or more data media interfaces. As will be further depicted and described below, system memory 424 may include at least one computer program product having a set (e.g., at least one) of program modules that are configured to carry out the functions of embodiments of the invention.

Program 432, having one or more sets of program modules 434, may be stored in memory 424 by way of example, and not limitation, as well as an operating system, one or more application programs, other program modules, and program data. Each of the operating systems, one or more application programs, other program modules, and program data, or some combination thereof, may include an implementation of a networking environment. Program modules 434 generally carry out the functions and/or methodologies of embodiments of the invention as described herein. Computer system 410 may also communicate with one or more external devices 412 such as a keyboard, a cell phone, a pointing device, a display 422, etc., or one or more devices that enable a user to interact with computer system 410 and any devices (e.g., network card, modem, etc.) that enable computer system 410 to communicate with one or more other computing devices. Such communication can occur via Input/Output (I/O) interfaces 420. Still yet, computer system 410 can communicate with one or more networks such as a local area network (LAN), a general wide area network (WAN), and/or a public network (e.g., the Internet) via network adapter 418. As depicted, network adapter 418 communicates with the other components of computer system 410 via bus 416. It should be understood that although not shown, other hardware and software components, such as microcode, device drivers, redundant processing units, external disk drive arrays, RAID systems, tape drives, and data archival storage systems may be used in conjunction with computer system 410.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a,” “an,” and “the” are intended to include the plural forms as well, unless the context clearly indicates otherwise.

The description of the present invention has been presented for purposes of illustration and description, but is not intended to be exhaustive or limited to the invention in the form disclosed. Many modifications and variations will be apparent to persons of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus's (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for requesting a recording of a focal point in a group event, the method comprising:
receiving, by one or more computer processors, a request from a first user for registration to a group, the group including at least two attendees of an event with an interest in recording the event;
receiving, by one or more computer processors, from the first user, a request to view one or more real time recordings from the group;
receiving, by one or more computer processors, from the first user, based, at least in part, on the one or more real time recordings, a request to record a focal point;
determining, by one or more computer processors, a second user in the group with a view of the focal point; and
sending, by one or more computer processors, the request to record the focal point to the second user.

2. The method of claim 1, wherein receiving, by one or more computer processors, from the first user, based, at least in part, on the one or more real time recordings, the request to record the focal point comprises receiving, by one or more computer processors, the focal point identified by one or more of the following: drawing a box around the focal point in one of the one or more real time recordings, touching the focal point such that the focal point is highlighted in one of the one or more real time recordings, moving a cursor to select the focal point in one of the one or more real time recordings, a text request identifying the focal point, or a voice command identifying the focal point.

3. The method of claim 1, wherein sending, by one or more computer processors, the request to record the focal point to the second user further comprises sending, by one or more computer processors, a notification of the request to the second user, the notification including one or more of the following: a marker on the focal point, a highlighted color on the focal point, a box around the focal point, a text request to record the focal point, a text request to record the focal point for a period time, a text request to record an action, an extracted still image with the focal point highlighted, and a voice request to record the focal point for a length of recording time.

4. The method of claim 1, wherein determining, by one or more computer processors, a second user in the group with a view of the focal point further comprises determining the focal point in a recording of the second user, based, at least in part, on one or more of the following: facial recognition of the focal point, object recognition of the focal point, gait recognition of the focal point, metadata on a device or a location of the second user.

5. The method of claim 1, further comprising:
receiving, by one or more computer processors, a denial of the request to record the focal point from the second user;
responsive to receiving the denial of the request to record the focal point, determining, by one or more computer processors, a third user in the group with a view of the focal point; and
sending, by one or more computer processors, a request to record the focal point to the third user.

6. The method of claim 1, wherein receiving, by one or more computer processors, from the first user, based, at least in part, on the one or more real time recordings, a request to record a focal point further comprises receiving an identification of the second user in the group with the view of the focal point.

7. The method of claim 1, further comprising:
receiving, by one or more computer processors, a request from at least one user in the group for a video of the focal point;
identifying, by one or more computer processors, the focal point in at least one recording of the one or more real time recordings from the group;
compiling, by one or more computer processors, the at least one recording into a video; and
sending, by one or more computer processors, the video to the at least one user.

8. The method of claim 7, wherein identifying, by one or more computer processors, the focal point in at least one recording of the one or more real time recordings from the group further comprises using at least one of: facial recognition of the focal point, object recognition of the focal point, and gait recognition of the focal point.

9. A computer program product for requesting a recording of a focal point in a group event, the computer program product comprising:
one or more computer readable storage media and program instructions stored on the one or more computer readable storage media, the program instructions comprising:
program instructions to receive a request from a first user for registration to a group, the group including at least two attendees of an event with an interest in recording the event;
program instructions to receive from the first user, a request to view one or more real time recordings from the group;
program instructions to receive from the first user, based, at least in part, on the one or more real time recordings, a request to record a focal point;
program instructions to determine a second user in the group with a view of the focal point; and
program instructions to send the request to record the focal point to the second user.

10. The computer program product of claim 9, wherein the program instructions to receive from the first user, based, at least in part, on the one or more real time recordings, the request to record the focal point comprises program instructions to receive the focal point identified by one or more of the following: drawing a box around the focal point in one of the one or more real time recordings, touching the focal point such that the focal point is highlighted in one of the one or more real time recordings, moving a cursor to select the focal point in one of the one or more real time recordings, a text request identifying the focal point, or a voice command identifying the focal point.

11. The computer program product of claim 9, wherein the program instructions to send the request to record the focal point to the second user further comprises program instructions to send a notification of the request to the second user, the notification including one or more of the following: a marker on the focal point, a highlighted color on the focal point, a box around the focal point, a text request to record the focal point, a text request to record the focal point for a period time, a text request to record an action, an extracted still image with the focal point highlighted, and a voice request to record the focal point for a length of recording time.

12. The computer program product of claim 9, wherein the program instructions to determine a second user in the group with a view of the focal point further comprise program instructions to determine the focal point in a recording of the second user, based, at least in part, on one or more of the following: facial recognition of the focal point, object recognition of the focal point, gait recognition of the focal point, metadata on a device or a location of the second user.

13. The computer program product of claim 9, further comprising:
program instructions to receive a denial of the request to record the focal point from the second user;
responsive to receiving the denial of the request to record the focal point, program instructions to determine a third user in the group with a view of the focal point; and
program instructions to send a request to record the focal point to the third user.

14. The computer program product of claim 9, further comprising:
program instructions to receive a request from at least one user in the group for a video of the focal point;
program instructions to identify the focal point in at least one recording of the one or more real time recordings from the group;
program instructions to compile the at least one recording into a video; and
program instructions to send the video to the at least one user.

15. The computer program product of claim 14, wherein program instructions to identify the focal point in at least one recording of the one or more real time recordings from the group further comprise program instructions to use at least one of: facial recognition of the focal point, object recognition of the focal point, and gait recognition of the focal point.

16. A computer system for requesting a recording of a focal point in a group event, the system comprising:
one or more computer processors;
one or more computer readable storage media;
program instructions stored on at least one of the one or more computer readable storage media for execution by at least one of the one or more computer processors, the program instructions comprising:
program instructions to receive a request from a first user for registration to a group, the group including at least two attendees of an event with an interest in recording the event;
program instructions to receive from the first user, a request to view one or more real time recordings from the group;
program instructions to receive from the first user, based, at least in part, on the one or more real time recordings, a request to record a focal point;
program instructions to determine a second user in the group with a view of the focal point; and
program instructions to send the request to record the focal point to the second user.

17. The computer system of claim 16, wherein the program instructions to receive from the first user, based, at least in part, on the one or more real time recordings, the request to record the focal point comprises program instructions to receive the focal point identified by one or more of the following: drawing a box around the focal point in one of the one or more real time recordings, touching the focal point such that the focal point is highlighted in one of the one or more real time recordings, moving a cursor to select the focal point in one of the one or more real time recordings, a text request identifying the focal point, or a voice command identifying the focal point.

18. The computer system of claim 16, wherein the program instructions to send the request to record the focal point to the second user further comprise program instructions to send a notification of the request to the second user, the notification includes one or more of the following: a marker on the focal point, a highlighted color on the focal point, a box around the focal point, a text request to record the focal point, a text request to record the focal point for a period time, a text request to record an action, an extracted still image with the focal point highlighted, and a voice request to record the focal point for a length of recording time.

19. The computer system of claim 16, wherein program instructions to receive from the first user, based, at least in part, on the one or more real time recordings, a request to record a focal point further comprise program instructions to receive an identification of the second user in the group with the view of the focal point.

20. The computer system of claim 16, further comprising:
program instructions to receive a request from at least one user in the group for a video of the focal point;
program instructions to identify the focal point in at least one recording of the one or more real time recordings from the group;
program instructions to compile the at least one recording into a video; and
program instructions to send the video to the at least one user.
